(19) United States
(12) Patent Application Publication
(10) Pub. No.: US 2024/0416488 A1
(43) Pub. Date: Dec. 19, 2024

(54) PROTECTIVE CAP

(71) Applicant: YOSHINO GYPSUM CO., LTD., Tokyo (JP)

(72) Inventors: Katsumi NIIMI, Tokyo (JP); Masato OHTSUBO, Tokyo (JP); Masato UESHIMA, Tokyo (JP)

(21) Appl. No.: 18/698,586

(22) PCT Filed: Feb. 22, 2023
(86) PCT No.: PCT/JP2023/006562

§ 371 Date: Apr. 4, 2024

(30) Foreign Application Priority Data
Mar. 4, 2022 (JP) 2022-033933

(51) Int. Cl. B25B 21/00

(52) U.S. Cl. CPC B25B 21/00

(57) ABSTRACT

A protective cap to be mounted to a power type rotary tool for screw driving, the protective cap including a main body portion; a cushion portion arranged above the main body portion, and formed of a material having a rubber hardness that is lower than a rubber hardness of the main body portion; and a through hole penetrating between an upper surface of the cushion portion and a lower surface of the main body portion.

### TECHNICAL FIELD

The present invention relates to a protective cap.

### BACKGROUND OF THE INVENTION

As a work method for creating a plate-like body such as a ceiling board, a floor material, a wall material, etc., a work method in which a screw is driven in from the surface side of the plate-like body to fix the plate-like body to a base material, etc., has been known conventionally.

However, when the plate-like body is fixed by the screw by using a power type rotary tool for screw driving, there is a case where a dent is formed in the plate-like body, the dent being a circular shape corresponding to the shape of the tip portion of the rotary tool, or an arcuate shape which is a part of a circle. A dent has been formed in the case where the screw is driven in too deeply, or when the screw driving is performed while the rotary tool is tilted. In particular, in recent years, as ceiling boards, for example, the use of a soft plate-like body with a light specific gravity from the viewpoint of preventing the ceiling from falling has been increasing, and the aforementioned dent has been easily formed.

When a circular dent or the like is formed in a plate-like body such as a ceiling board, the dent becomes conspicuous such that the appearance is degraded when diagonally illuminated. Further, in order to prevent a circular dent or the like from being formed, it is required to carefully work so as not to drive the screw too far, and so as not to tilt the power type rotary tool for driving the screw, thereby reducing the work speed.

Therefore, in order to prevent a dent from being formed in the plate-like body, a protective cap to be mounted to the power type rotary tool for driving the screw has been studied conventionally.

For example, Patent Document 1 discloses an attachment for the power type rotary tool consisting of a face plate part and a mounting part, and having a soft part on the surface of the face plate part.

### RELATED ART DOCUMENTS

### Patent Document

Patent document 1: Japanese Unexamined Patent Application Publication No. 2009-39789

### SUMMARY OF THE INVENTION

### Problems to be Solved by the Invention

Incidentally, in recent years, further weight reduction has been attempted for plate-like bodies such as ceiling boards, in which a dent is particularly prone to being formed. For this reason, the attachment for a power type rotary tool disclosed in Patent Document 1 may not be able to sufficiently prevent the formation of dent having circular shapes, etc., in plate-like bodies.

In view of the above problems of the conventional technology, an object of the present invention is to provide a protective cap capable of preventing the formation of a circular or arcuate shape dent in a plate-like body when a screw is driven in by a power type rotary tool for screw driving.

### Means for Solving the Problem

In order to solve the above problem, the present invention can provide a protective cap to be mounted to a power type rotary tool for screw driving, the protective cap including:
a main body portion;
a cushion portion arranged above the main body portion, and formed of a material having a rubber hardness that is lower than a rubber hardness of the main body portion; and
a through hole penetrating between an upper surface of the cushion portion and a lower surface of the main body portion.

### Effects of the Invention

According to the present invention, it is possible to provide a protective cap capable of preventing the formation of a circular or arcuate shape dent in a plate-like body when a screw is driven in by a power type rotary tool for screw driving.

### BRIEF DESCRIPTION OF THE DRAWINGS

FIG. 1A is an explanatory diagram of a protective cap in an embodiment of the present invention.

FIG. 1B is an explanatory diagram of a protective cap in an embodiment of the present invention.

FIG. 2 is an explanatory diagram of a protective cap in an embodiment of the present invention when the protective cap is mounted to a screw driving power type rotary tool.

FIG. 3 is an explanatory diagram of the protective cap in an embodiment of the present invention.

FIG. 4A is an explanatory diagram of a groove portion provided on the outer surface.

FIG. 4B is an explanatory diagram of the groove portion provided on the outer surface.

FIG. 5A is an explanatory diagram of a fixing member.

FIG. 5B is an explanatory diagram of the fixing member.

### DETAILED DESCRIPTION OF THE INVENTION

Embodiments of the present invention will be described below, but the present invention is not limited to the following embodiments, and various modifications and substitutions can be made to the following embodiments without departing from the scope of the present invention.

### [Protective Cap]

The protective cap according to the present embodiment is a protective cap mounted on a power-driven rotary tool for screw driving. Here, the screw includes all screws for fixing a plate-like body such as an interior wall plate or a ceiling plate to a base. The power type rotary tool (hereinafter also referred to simply as a “rotary tool”) for screw driving has a bit fixing part for fixing a bit having a tip shape corresponding to a slit-like groove portion provided on the screw head or a cross shape or the like. By rotating the bit fixing part by the power of a motor or the like provided inside the tool, the screw can be rotated via the bit and the screw can be driven into a plate-like body.

### (1) Outer Shape of Protective Cap

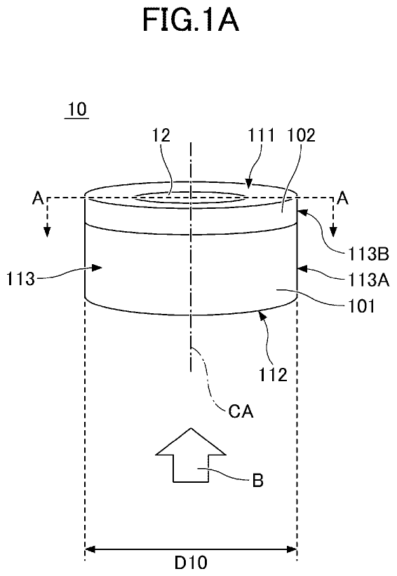

FIG. 1A illustrates a perspective view of the protective cap of the present embodiment, and FIG. 1B illustrates a cross-sectional view of the protective cap of the present embodiment. FIG. 1B is a cross-sectional view taken along line A-A of FIG. 1A.

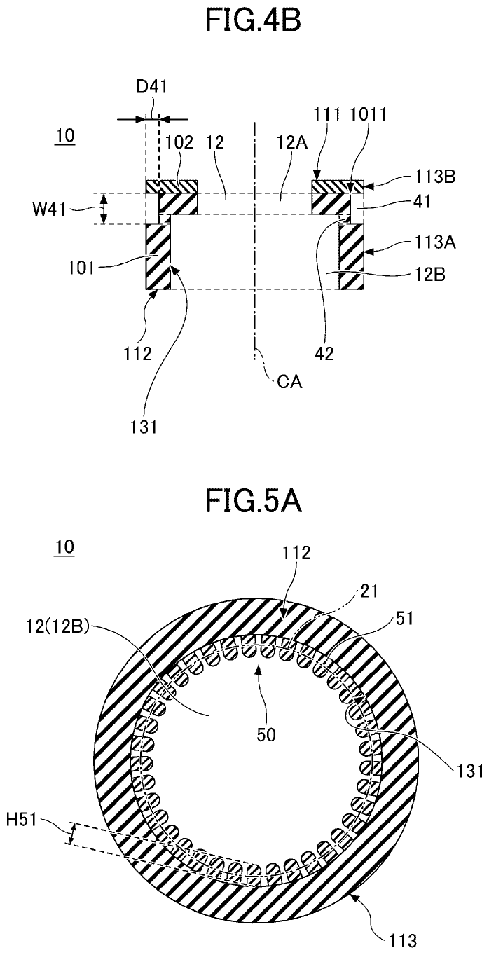

Although the outer shape of a protective cap 10 of the present embodiment is not particularly limited, the outer shape can be, for example, a columnar shape and, in particular, preferably a cylindrical shape as illustrated in FIG. 1A. As will be described later, the protective cap 10 of the present embodiment may be, for example, a case in which an outer surface 113 (113A, 113B) has a groove portion 41 (see FIGS. 4A, 4B). For this reason, the columnar shape and the cylindrical shape referred to herein are not limited to a shape in a geometrically strict sense.

As illustrated in FIGS. 1A and 1B, the protective cap 10 may include a topside 111 and an underside 112, and a through hole 12 penetrating between the topside 111 and the underside 112. The topside 111 is also an upper surface 1022 of a cushion portion 102, and the underside 112 is also a lower surface of a main body portion 101.

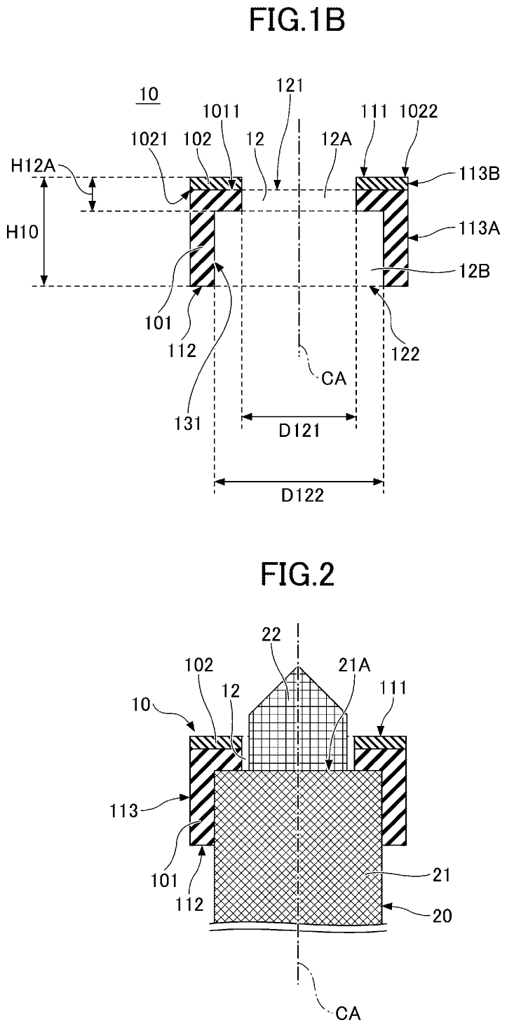

FIG. 2 illustrates an explanatory diagram when the protective cap 10 of the present embodiment is mounted on a rotary tool 20. FIG. 2 is a cross-sectional view of a plane through a central axis CA of the protective cap 10, when the protective cap 10 is mounted on the rotary tool 20.

As illustrated in FIG. 2, the protective cap 10 of the present embodiment can be mounted on a tip portion 21 of the rotary tool 20. At this time, the protective cap 10 can be mounted on the tip portion 21 of the rotary tool 20 by inserting the tip portion 21 of the rotary tool 20 into the through hole 12 from the underside 112 side of the protective cap 10.

The tip portion 21 of the rotary tool 20 is a bit fixing part (chuck part) for attaching a bit 22, and the tip portion 21 is the part of the rotary tool 20 that comes closest to the plate-like body (hereinafter, not illustrated) except for the bit 22 when driving a screw using the rotary tool 20. By mounting the protective cap 10 to the tip portion 21 of the rotary tool 20, it is possible to prevent a surface 21A facing the plate-like body at the tip portion 21 of the rotary tool 20 from coming into direct contact with the plate-like body when driving a screw into the plate-like body. Thus, it is possible to reduce the formation of a circular or arcuate shaped dent in the plate-like body.

Although the size of the protective cap 10 of the present embodiment is not particularly limited, for example, a maximum diameter D10 (see FIG. 1A) is preferably greater than or equal to 24 mm and less than or equal to 50 mm, and more preferably greater than or equal to 25 mm and less than or equal to 28 mm. By making the maximum diameter D10 greater than or equal to 24 mm, the protective cap 10 can be easily mounted to the tip portion 21 of the rotary tool 20, and when the protective cap 10 comes in contact with the plate-like body, the pressing pressure by the rotary tool 20 is distributed to sufficiently prevent the formation of a dent in the plate-like body. Further, by making the maximum diameter D10 less than or equal to 50 mm, the protective cap 10 can be used even in a narrow place such as an entry corner part, and the screwing position is not obstructed from the field of view and workability is not lowered.

The maximum diameter D10 means the diameter at the point where the outer shape has a circular shape and the diameter becomes the largest in the cross section perpendicular to the central axis CA.

A thickness H10 (see FIG. 1B) of the protective cap 10 is preferably selected so as not to be easily detached when mounted on the rotary tool 20 and so as to give a sufficient thickness to the portion of the tip portion 21 of the rotary tool 20 (see FIG. 2) covering the surface 21A facing the plate-like body. Thus, the thickness H10 of the protective cap 10 is preferably greater than or equal to 11 mm and less than or equal to 20 mm. In particular, the thickness H10 of the protective cap 10 is more preferably greater than or equal to 11 mm and less than or equal to 16 mm.

Hereinafter, the parts of the protective cap 10 of the present embodiment will be described.

### (2) Through Hole

The through hole 12 is preferably disposed along the central axis CA of the protective cap 10 as illustrated in FIG. 1B. The through hole 12 is a hole for inserting the rotary tool 20 (see FIG. 2). As illustrated in FIGS. 1B and 2, the through hole 12 may have a first opening 121 for exposing the bit 22 of the rotary tool 20 (see FIG. 2) on the topside 111 side, and a second opening 122 for inserting the rotary tool 20 on the underside 112 side.

The through hole 12 may be configured such that the diameter D121 of the first opening 121, which is an opening on the topside 111 side, is smaller than the diameter D122 of the second opening 122 on the underside 112 side. Therefore, the through hole 12 may have a structure in which, for example, the first through hole 12A and the second through hole 12B having a cylindrical shape with different diameters are connected.

By making the diameter D121 of the first opening 121 smaller than the diameter D122 of the second opening 122, while exposing the bit 22 as illustrated in FIG. 2, the surface 21A facing the plate-like body at the tip portion 21 of the rotary tool 20 can be covered by the protective cap 10.

A length H12A (see FIG. 1B) of the first through hole 12A is not particularly limited. The length H12A of the first through hole 12A is the thickness of the member covering the surface 21A facing the plate-like body at the tip portion 21 of the rotary tool 20, and, therefore, it is preferable to select the length so as to sufficiently protect the plate-like body. The length H12A of the first through hole 12A may be greater than or equal to 2 mm and less than or equal to 8 mm, for example.

### (3) Cushion Portion

As illustrated in FIGS. 1A and 1B, the protective cap 10 of the present embodiment may have the main body portion 101 and the cushion portion 102 arranged above the main body portion 101 and made of a material having lower rubber hardness than the main body portion 101. The aforementioned through hole 12 is provided so as to penetrate the main body portion 101 and the cushion portion 102.

By providing the cushion portion 102 in this manner, even when the topside 111 of the protective cap 10 is in contact with the plate-like body, the formation of a dent in the plate-like body can be prevented.

As illustrated in FIGS. 1A and 1B, the cushion portion 102 is preferably provided such that the entire topside 111 of the protective cap 10 is covered. That is, the upper surface 1022 of the cushion portion 102 preferably coincides with the topside 111 of the protective cap 10.

The cushion portion 102 and the main body portion 101 may be joined to form an integral molded article, or these members may be bonded together with an adhesive or adhesive tape. The cushion portion 102 and the main body portion 101 may be configured to be detachable from each other, and for example, an adhesive or adhesive tape may be selected so as to allow these members to be detachably bonded. The bonding surfaces of the cushion portion 102 and the main body portion 101, that is, a lower surface 1021 of the cushion portion 102 and the upper surface 1011 of the main body portion 101, may be flat horizontal surfaces in order to enhance the bonding strength of these members.

Although the shape of the upper surface 1022 of the cushion portion 102 is not particularly limited, the shape may be a flat horizontal surface, that is, a flat surface, as illustrated in FIGS. 1A and 1B.

The above-mentioned “flat” means that no irregularities are intentionally formed, but does not exclude a case where irregularities caused by the manufacturing process are included. Further, although the horizontal surface is preferably a surface orthogonal to the central axis CA, this does not mean orthogonality (right angle) in a strictly geometrical sense, and this does not exclude a case where errors caused by the manufacturing process, etc., are caused.

The cushion portion 102 may contain a material having a lower rubber hardness than the main body portion 101, and may be formed of a material having a lower rubber hardness. The same elastic material as that of the main body portion 101 may be used for the cushion portion 102, or a material such as felt, plastic foam, or a gel-like body may be used.

The rubber hardness of the cushion portion 102 is preferably 30 or more and 60 or less.

Further, the rubber hardness of the cushion portion 102 is preferably 10 or more lower than the rubber hardness of the plate-like body to which a screw is to be driven in. Therefore, when the rubber hardness of the cushion portion 102 is H102 and the rubber hardness of the plate-like body is HB, it is preferable that HB−H102≥10. When the rubber hardness of the plate-like body varies depending on the position, the rubber hardness HB of the plate-like body means the rubber hardness around the position where the screw is driven in within the plate-like body.

For example, when the rubber hardness HB of the plate-like body is 50, the rubber hardness of the cushion portion 102 is preferably 40 or less. The rubber hardness of 40 is a numerical value obtained by subtracting the above 10 from the rubber hardness HB of the plate-like body.

The surface of the cushion portion 102 may be provided with a resin sheet for preventing dirt adhesion or a rubber sheet having a hardness approximately equal to that of the main body portion 101.

In this specification, rubber hardness means Type A durometer hardness, that is, rubber hardness measured by the Type A durometer hardness test defined in JIS K 6253-3 (2012). Even when the cushion portion 102 is made of felt or the like, the rubber hardness can be evaluated by the Type A durometer hardness test.

The color of the topside 111 of the protective cap 10 is preferably close to that of the plate-like body. This is because even when a part of the protective cap 10 adheres to the plate-like body due to friction, when the color of the protective cap 10 is close to that of the plate-like body, the appearance can be prevented from being damaged. Plate-like bodies such as ceiling boards, floor materials, and wall materials are generally close to gray or white, and, therefore, it is preferable that the topside 111 of the protective cap 10 is also gray or white. Thus, it is preferable that the upper surface 1022 of the cushion portion 102 also has the above color tone.

The outer surface 113B of the cushion portion 102 and the outer surface 113A of the main body portion 101 may have the same distance from the central axis CA as illustrated in FIG. 1B.

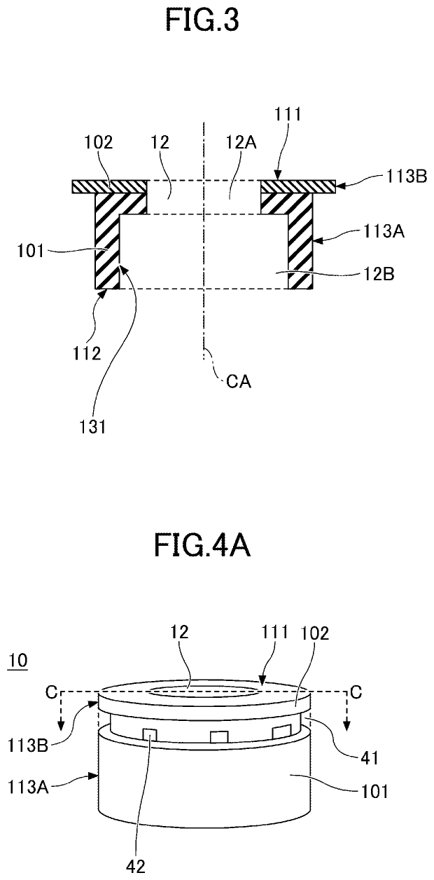

However, the embodiment is not limited to this configuration, and as illustrated in FIG. 3, the outer surface 113B of the cushion portion 102 may have a shape that is located outside the outer surface 113A of the main body portion 101. The outer surface here means the direction away from the central axis CA of the protective cap 10.

By arranging the outer surface 113B of the cushion portion 102 outside the outer surface 113A of the main body portion 101, the cushion portion 102 can easily be deformed downward, that is, toward the underside 112. Therefore, even in a case where screw-driving is performed when the rotation axis of the bit 22 of the rotary tool 20 is tilted from the direction perpendicular to the plate-like body (hereinafter, also described as “the state in which the rotary tool 20 is tilted”) and the outer periphery of the topside 111 contacts the plate-like body, the formation of a dent in the plate-like body can be particularly prevented.

### (4) Main Body Part

As illustrated in FIG. 2, for example, the main body portion 101 is arranged below the cushion portion 102 and becomes a member in contact with the tip portion 21 when the protective cap 10 is mounted on the tip portion 21 of the rotary tool 20. That is, the protective cap 10 of the present embodiment may have a structure in which the main body portion 101 and the cushion portion 102 are laminated.

The material forming the main body portion 101 is not particularly limited; however, from the viewpoint of protecting the plate-like body by deforming in accordance with the shape of the tip portion 21 of the rotary tool 20 inserted into the through hole 12, it is preferable to include an elastic material and more preferably to be formed of an elastic material. For example, rubber may be used as an elastic material, and silicone rubber may be particularly preferably used as an elastic material. This is because, in the case of silicone rubber, it is possible to prevent chips, which are produced when a screw is struck on the plate-like body, from adhering to the protective cap 10 and to prevent the surface of the plate-like body from being stained.

Other than the above silicone rubber, as the elastic material included in the protective cap 10, for example, natural rubber, nitrile rubber, silicon rubber, fluorine rubber, urethane rubber, acrylic rubber, isoprene rubber, styrene rubber, butadiene rubber, butyl rubber, isobutylene isoprene rubber, ethylene propylene rubber, ethylene propylene diene rubber, ethylene vinyl acetate rubber, chloroprene rubber, hyperon (chlorosulfonated polyethylene) chlorinated polyethylene rubber, epichlorohydrin rubber, polysulfide rubber, etc., may be used.

The rubber hardness of the main body portion 101 is preferably 30 or more and 90 or less, more preferably 50 or more and 80 or less.

This is because, when the rubber hardness is in the above range, the protective cap 10 can be easily deformed according to the shape of the tip portion 21 of the rotary tool 20 and fixed to the rotary tool 20. Further, when the rubber hardness is in the above range, the protective cap 10 can exhibit a sufficient cushioning property and particularly prevent the formation of a dent in the plate-like body.

### (5) Groove Portion

The protective cap 10 of the present embodiment may have a groove portion 41 formed along the circumferential direction on the outer surface 113A of the main body portion 101. FIGS. 4A and 4B illustrate a perspective view and a cross-sectional view, respectively, in the case where the groove portion 41 is provided. FIG. 4B is a cross-sectional view taken along line C-C of FIG. 4A.

By providing the groove portion 41, the cushion portion 102 can easily be deformed downward, i.e., toward the underside 112. Therefore, even when screw-driving is performed when the rotary tool 20 is in a tilted state and the outer periphery of the topside 111 comes into contact with the plate-like body, the formation of a dent in the plate-like body can be particularly prevented.

Although the position of the groove portion 41 in the height direction and the depth D41 and width W41 of the groove portion 41 are not particularly limited, it is preferable to select the size and position of the groove portion 41 such that the cushion portion 102 can easily deform to the groove portion 41 side. The groove portion 41 is preferably provided so as to be in contact with, for example, the upper surface 1011 of the main body portion 101, that is, exposed from the upper surface 1011 of the main body portion 101.

For example, the depth D41 of the groove portion 41 can be 2 mm, and the width W41 can be 2 mm.

In the present embodiment, the depth D41 of the groove portion 41 is preferably 1 mm or more. The depth D41 of the groove portion 41 is preferably half or less of the thickness of the protective cap 10 at the portion where the groove portion 41 is provided. The thickness of the protective cap 10 at the portion where the groove portion 41 is provided means the distance between the inner peripheral surface 131 of the through hole 12 and the outer surface 113 at the portion where the groove portion 41 is provided.

In FIG. 4B, the outer surface 113B of the cushion portion 102 and the outer surface 113A of the main body portion 101 are located on the same plane, but the present embodiment is not limited to this configuration. For example, as described above, the outer surface 113B of the cushion portion 102 may be located outside the outer surface 113A of the main body portion 101.

FIGS. 4A and 4B illustrate an example in which the groove portion 41 is provided so as to be in contact with the upper surface 1011 of the main body portion 101, that is, the groove portion 41 is provided so as to include the boundary between the cushion portion 102 and the main body portion 101, but the present embodiment is not limited to the this configuration. The groove portion 41 may be provided closer towards the underside 112 relative to the example illustrated in FIGS. 4A and 4B. In this case, a first outer peripheral area including the cushion portion 102 and a part of the main body portion 101 above the groove portion 41, is arranged above the groove portion 41. Further, a second outer peripheral area which is a part of the main body portion 101 below the groove portion 41, is arranged below the groove portion 41.

In this case also, the outer surface of the first outer peripheral area and the outer surface of the second outer peripheral area may be at the same distance from the center axis CA. Further, the outer surface of the first outer peripheral area may have a shape located outside the outer surface of the second outer peripheral area. The outer surface here means the direction away from the central axis CA of the protective cap 10.

By arranging the outer surface of the first outer peripheral area outside the outer surface of the second outer peripheral area, the first outer peripheral area can easily be deformed downward, i.e., toward the underside 112. Therefore, even when the outer periphery of the topside 111 comes in contact with the plate-like body by performing screw driving while the rotary tool 20 is tilted, the formation of a dent in the plate-like body can be particularly prevented.

In the above configuration, the shape of the cushion portion 102 is not particularly limited. For example, the cushion portion 102 may be shaped to cover a plane portion of the upper surface 1011 of the main body portion 101, to cover the groove portion 41, or to cover the outer surface of the first outer peripheral area.

The groove portion 41 may also have a communication hole 42 communicating between the groove portion 41 and the through hole 12, as illustrated in FIGS. 4A and 4B, for example. By providing the communication hole 42, the cushion portion 102 can be particularly easily deformed downward. Therefore, the formation of a dent in the plate-like body can be particularly prevented.

### (6) Fixing Member

The protective cap 10 of the present embodiment may have a fixing member 50 including a plurality of the protrusions 51 in the inner peripheral surface 131 of the through hole 12.

The outer diameter of the tip portion 21 of the rotary tool 20 may vary depending on the manufacturer or the like of the rotary tool 20. If the inner diameter of the through hole 12 of the protective cap 10 is large relative to the outer diameter of the tip portion 21 of the rotary tool 20, a gap may be formed between the inner peripheral surface of the protective cap 10 and the tip portion 21, and the protective cap 10 may not be fixed to the tip portion 21.

Therefore, if the outer diameter of the tip portion 21 of the rotary tool 20 is significantly different from the inner diameter of the through hole 12 of the protective cap 10, the position of the protective cap 10 may shift during use of the rotary tool 20, and the plate-like body may not be sufficiently protected.

Therefore, it is preferable that the protective cap 10 of the present embodiment has the fixing member 50 including a plurality of the protrusions 51 in the inner peripheral surface 131 of the through hole 12, especially in the inner peripheral surface (inner side surface) of the second through hole 12B, as described above, so that the protective cap 10 can be attached regardless of the size of the tip portion 21 of the rotary tool 20.

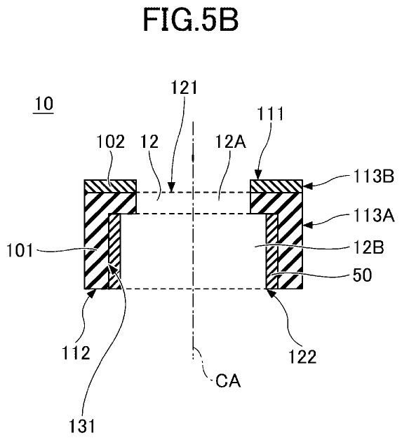

The fixing member 50 will be described with reference to FIGS. 5A and 5B. FIG. 5A is a bottom view of the protective cap 10 with the fixing member 50 and corresponds to a view along the block arrow B in FIG. 1A. FIG. 5B is a cross-sectional view at line A-A (see FIG. 1A) of the protective cap 10 with the fixing member 50.

The fixing member 50 may include a plurality of the protrusions 51, as illustrated in FIG. 5A, for example, and a plurality of the protrusions 51 may be provided along the circumferential direction of the inner peripheral surface 131 of the through hole 12, as illustrated in FIG. 5A. By providing a plurality of the protrusions 51 on the inner peripheral surface 131 of the through hole 12 in this manner, when the rotary tool 20 is inserted into the through hole 12 from the underside 112 of the protective cap 10, the protrusions can contract in accordance with the size of the tip portion 21 indicated by the two-dot chain line, so that the protrusions 51 can adhere to the outer surface of the tip portion 21. Therefore, the height H51 and the like of the protrusions 51 can be selected in accordance with the size range of the tip portion 21 of the corresponding rotary tool 20.

In FIG. 5A, the size and shape of the protrusion 51 are constant, but the fixing member 50 may include the protrusions 51 having different heights and shapes.

The fixing member 50 may be provided on at least a part of the inner peripheral surface 131 of the through hole 12; however, in order to enhance adhesion to the tip portion 21, it is preferable that the fixing member be provided on the entire inner peripheral surface 131 of the second through hole 12B, as illustrated in FIG. 5B, for example.

### (7) Chamfered Portion

The protective cap 10 of the present embodiment may also have a chamfered portion (not illustrated) at which the portion between the upper surface 1011 and the outer surface 113 (113A) of the main body portion 101 is chamfered. The chamfered portion may be formed over the entire outer periphery of the upper surface 1011 of the main body portion 101.

Although the shape of the chamfered portion is not particularly limited, for example, in a cross section through the central axis CA of the protective cap 10, the chamfered portion may have, for example, an arc shape or a linear shape.

When the main body portion 101 has a chamfered portion at which the portion between the upper surface 1011 and the outer surface 113 (113A) is chamfered, it is possible to prevent the formation of a dent in the plate-like body even when the rotary tool 20 (see FIG. 2) performs screw driving in a tilted state and the chamfered portion comes into contact with the plate-like body.

When the main body portion 101 has a chamfered portion, the cushion portion 102 is preferably provided so as to cover at least a part of the chamfered portion as well as the part of the plane of the upper surface 1011 of the main body portion 101.

Although the protective cap has been described in the above embodiments, the present invention is not limited to the above embodiments. Various variations and changes can be made within the scope of the gist of the present invention described in the claims.

The present international application is based upon and claims priority to Japanese Patent Application No. 2022-033933 filed on Mar. 4, 2022, the entire contents of which are incorporated herein by reference.

### EXPLANATION OF REFERENCE NUMERALS

10 protective cap
H10 height
D10 diameter
CA central axis
111 topside
112 underside
113 outer surface
12 through hole
12A first through hole
H12A length
12B second through hole
121 first opening
D121 diameter
122 second opening
D122 diameter
131 inner peripheral surface
101 main body portion
1011 upper surface
113A outer surface
102 cushion portion
1021 lower surface
1022 upper surface
113B outer surface
20 rotary tool
21 tip portion
22 bit
21A surface
41 groove portion
42 communication hole
D41 depth
W41 width
50 fixing member
51 protrusion
H51 height

1. A protective cap to be mounted to a power type rotary tool for screw driving, the protective cap comprising:
a main body portion; and
a cushion portion arranged above the main body portion, and formed of a material having a rubber hardness that is lower than a rubber hardness of the main body portion; wherein
a through hole penetrates between an upper surface of the cushion portion and a lower surface of the main body portion.

2. The protective cap according to claim 1, wherein the upper surface of the cushion portion is a plane.

3. The protective cap according to claim 1, further comprising:
a groove portion formed along a circumferential direction on an outer surface of the main body portion.

4. The protective cap according to claim 1, further comprising:
a fixing member including a plurality of protrusions on an inner peripheral surface of the through hole.

5. The protective cap according to claim 1, wherein the main body portion has the rubber hardness of 30 or more and 90 or less.

6. The protective cap according to claim 1, wherein the cushion portion has the rubber hardness of 30 or more and 60 or less.
